(19) United States
(12) Patent Application Publication
(10) Pub. No.: US 2021/0212301 A1
(43) Pub. Date: Jul. 15, 2021

(54) ARTIFICIAL BAIT FISH WITH IMBEDDED BLADE AND RELATED METHOD OF MANUFACTURE

(71) Applicant: Soco Baits, Brewerton, NY (US)

(72) Inventors: Nicholas J. Sokolowski, Brewerton, NY (US); David J. Sokolowski, Brewerton, NY (US)

(21) Appl. No.: 16/739,761

(22) Filed: Jan. 10, 2020

(51) Int. Cl. A01K 85/02

(52) U.S. Cl. CPC A01K 85/02

(57) ABSTRACT

An artificial bait fish is fabricated from a soft plastic body formed in the shape of a fish and having an embedded blade made from aluminum or other suitable material. The bait fish is fabricated using a overmolding process in which the embedded blade includes a colored portion on at least one surface to provide visibility. The artificial bait fish includes features that permit use with various fishing rigs.

### BACKGROUND

This application is generally directed to the field of fish lures and more specifically to an overmolded soft plastic bait fish having a number of attendant features including an imbedded blade, as well as a related method of manufacturing same.

Various types of bait fish have long since been used by fishermen. In general, bait fish may be classified as either natural bait fish or artificial bait fish. Both natural bait fish and artificial bait fish have been used with a fishing hook and/or a fishing lure. When a natural bait fish is used with a fishing lure, the fishing lure enhances the motion, action, sound and/or appearance of the natural bait fish. In the event that the natural bait fish is dead, the fishing lure provides the motion, action and/or sound to the natural bait fish.

Numerous attempts have been made to create or design artificial fishing lures that realistically simulate live, healthy, feeding baitfish. Usually the fishing lure provides the total attraction for the artificial bait fish and simulates the motion, action, sound and/or appearance of a natural bait fish.

There is a prevailing need in the field to provide improved and durable fishing lures and more specifically, artificial bait fish that more accurately simulates a live bait fish for fishermen that prefer to use an artificial bait fish instead of a natural bait fish or the like.

There is another prevailing need in the field to provide an improved artificial bait fish that provides a natural swimming movement of the improved artificial fish bait through the water.

There is yet another general need in the field to provide an artificial bait fish that is adaptable for use various types and arrangement of conventional fishing hooks and existing fishing apparatus and in which the artificial bait fish is adaptable to a variety of uses, modes of operation, and applications.

The foregoing outlines the general state of the art as well as the prevailing needs in the field for an artificial bait fish. The present invention is intended to be responsive to these needs as discussed in greater detail herein.

### BRIEF DESCRIPTION

Therefore and according to one aspect, there is provided an artificial bait fish comprising a soft plastic body, which is substantially molded in the shape of a fish. A blade made preferably from a lightweight durable metal such as aluminum or other suitable hard material is embedded or impregnated within the soft plastic body during the molding process. The artificial bait fish is configured and sized for attachment to a meat head or other conventionally known fishing apparatus for trolling or other fishing applications.

In at least one version, the imbedded blade includes at least one colored strip that is applied to at least one surface of the blade. The colored strip can be attached to the blade by means of fasteners, adhesives or other means. According to at least one version, the colored strip(s) can be painted directly onto a surface(s) of the blade. The imbedded blade provides structural rigidity as the artificial bait fish moves through the water, while also enhancing visibility of the fishing lure during use. Preferably, the lower edge of the artificial bait fish is rounded to insure an optimal roll rate of a fishing rig having the artificial bait fish as it moves through the water.

According to at least one version, a ridge formed at a neck portion of the lure permits the herein described bait fish to be fitted into literally any sized meat rig head.

According to at least one preferred version, the artificial bait fish is designed with a tapered belly portion extending from the neck of the artificial bait fish and extending to the tail end thereof. This feature advantageously allows the lure to roll smoothly through the water during use, such as when fishing the lure on a right or left meat rig head.

According to another aspect, there is provided a method for manufacturing an artificial bait fish, the method comprising the steps of:
providing a blade made from a lightweight metal;
disposing the blade within a mold, the mold having at least one tab for retaining the blade; and
molding a soft plastic body in the shape of a fish about the blade within the mold wherein the blade is imbedded within the soft plastic body of the formed bait fish.

According to at least one version, the artificial bait fish includes a neck that is formed with a ridge that is sized and shaped to permit the artificial bait fish to be attached to various sized fishing rigs, such as meat heads.

In at least one embodiment, the artificial bait fish includes a tapered belly that facilitates the ability of the bait fish to roll within the water when moved during trolling or other fishing application.

One advantage that is provided by the herein described invention is that the herein described artificial bait fish is fairly easy to manufacture and use.

Another advantage provided is that the herein described artificial bait fish more accurately enhance the motion, action and appearance of natural bait fish during use, as compared to prior art versions.

Yet another advantage provided is that the herein described artificial bait fish is adaptable to a number of different fishing rigs and applications. In addition and in terms of manufacture, the herein described artificial bait fish can be mass produced for commercial sale.

The foregoing has outlined some of the pertinent features and advantages of the artificial bait fish of the present invention. The advantages should be construed as being merely illustrative of some of the more prominent features and applications in terms of use. Many beneficial results can be obtained by applying the present invention in a different manner or modifying the invention within the intended full scope of the invention. Accordingly, other features and advantages will be readily apparent from the following Detailed Description, which should be read in conjunction with the accompanying drawings.

### BRIEF DESCRIPTION OF THE DRAWINGS

FIG. 1 is a perspective view of an artificial bait fish that is manufactured in accordance with an exemplary embodiment;

FIG. 2(a) is a top plan view of the artificial bait fish of FIG. 1;

FIG. 2(b) is a bottom plan view of the artificial bait fish of FIGS. 1 and 2(a);

FIG. 3 is a top plan view of a blade imbedded as part of the artificial bait fish of FIGS. 1-2(b);

FIG. 4 depicts an exemplary mold used in the manufacture of the artificial bait fish of FIGS. 1 and 2;

FIG. 5(a) is a top plan view of an artificial bait fish made in accordance with the present invention that is installed in a fishing rig;

FIGS. 5(b) and 5(c) are top plan and side views of the artificial bait fish of FIG. 5(a) installed in another fishing rig.

### DETAILED DESCRIPTION

The following describes an embodiment of a soft plastic artificial bait fish, as well as a related method of manufacture and use of the artificial bait fish. It will be understood that the embodiment described is merely an example from which a number of alternative versions are possible. In addition and throughout the following description, a number of terms are used in order to provide a suitable frame of reference with regard to the accompanying drawings. These terms, which include “proximal”, “distal”, “outer”, “inner”, “top”, and “bottom”, “first” and “second” among others, should not limit the intended scope of the present invention unless so specifically indicated.

In addition, the accompanying drawings are merely intended to show salient features of the present invention. The drawings are not necessarily to scale and should not be used for scaling purposes.

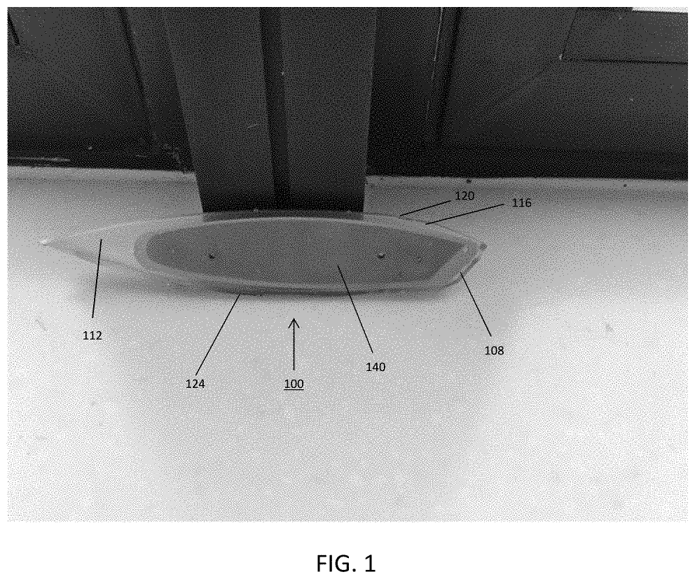

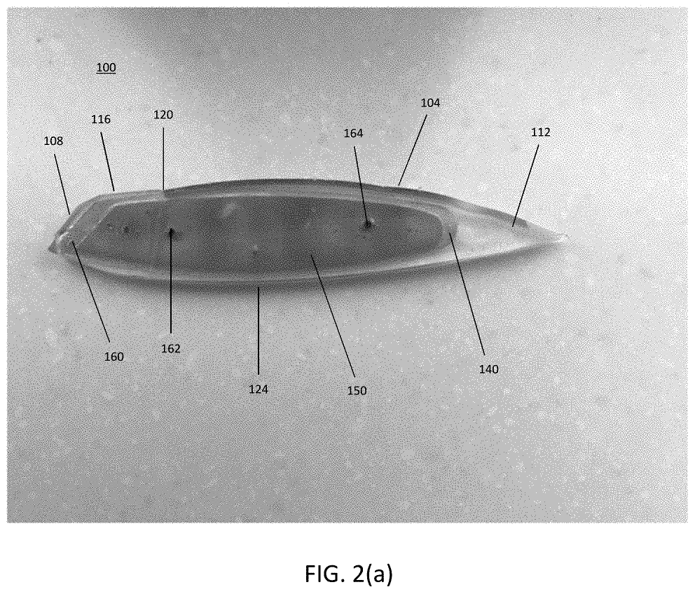

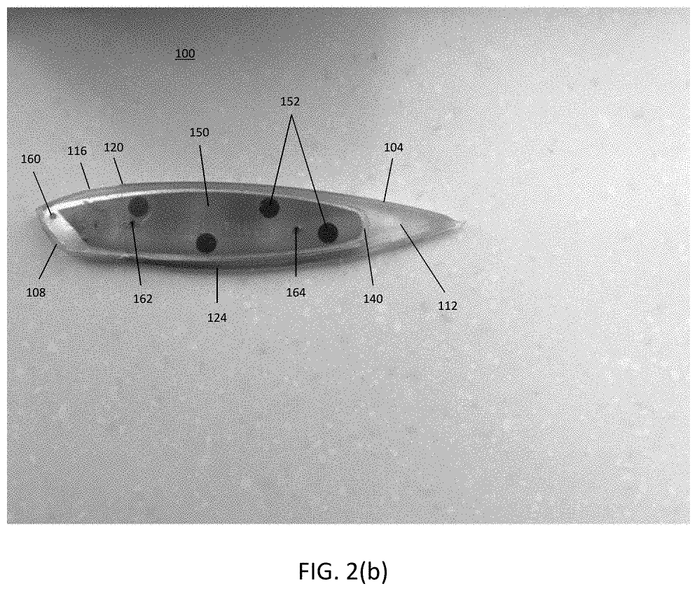

With reference to FIGS. 1-2(b), there is shown an artificial bait fish 100 made in accordance with the exemplary embodiment. The artificial bait fish 100 is defined by a body 104 made from a soft synthetic thermoplastic resin. The material of the body 104 is intended to include any polymeric material that is capable of being molded and understood by others to be a “soft plastic”. According to the present embodiment, the body 104 is made from plastisol and is fabricated, as discussed below, in the shape of a fish. In this embodiment, the artificial bait fish 100 is formed in the shape of a minnow, but it will be readily understood that the body 104 can easily assume other fish forms other than that presently depicted. The material of the body 104 may be clear (transparent to entering light) as in the present embodiment and colorless or alternatively can be clear and colored (translucent to entering light). In at least some embodiments, the body 104 can be made from a number of different colors.

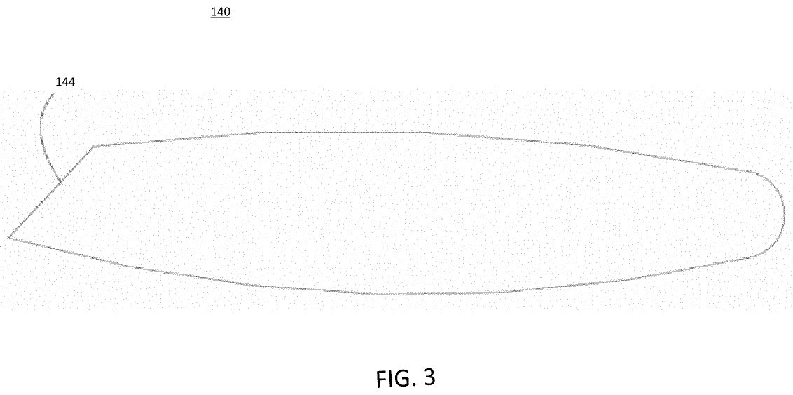

The body 104 of the artificial bait fish 100 is defined according to this exemplary embodiment by a first or distal end 108 (also referred throughout as the “head” or “head portion”) and a second or proximal end 112 (also referred to throughout as the “tail” or “tail end”). A blade 140, best shown in FIG. 3, is imbedded substantially within the interior of the molded body 104 as discussed herein.

According to this embodiment, the imbedded blade 140 is defined by a planar section of a lightweight and preferably non-corrosive metal, such as aluminum, although other literally any form of metal or plastic can be used, including but not limited to hard and durable polymers (polyamides, polyacrylic). As best shown in FIG. 3, the blade 140 is defined by an substantially elliptical shape with the exception of an angled front or distal end 144. According to this specific embodiment, a colored strip 150 with an adhesive backing is applied to opposing top and bottom sides of the blade 140. The colored strip 150 can also be attached to the blade 140 using a plurality of fasteners 152 mounted through recessed holes of the blade 140 such that the heads of the fasteners 152 do not protrude beyond the exterior surface of the blade 140 or the colored strips 150. Alternatively, the colored strips 150 can be attached to each side of the blade 140 using adhesives or other known means. The colored strip 150 can be made in some embodiments from vinyl tape or from paper having an adhesive backing. According to yet another version, the opposing sides of the blade 140 can be painted. As discussed herein, the colored strips 150 provide enhanced visibility of the artificial bait fish 100 in the water. In this example, the body 104 of the artificial bait fish 100 is substantially clear and each of the colored strips 150 are green in color.

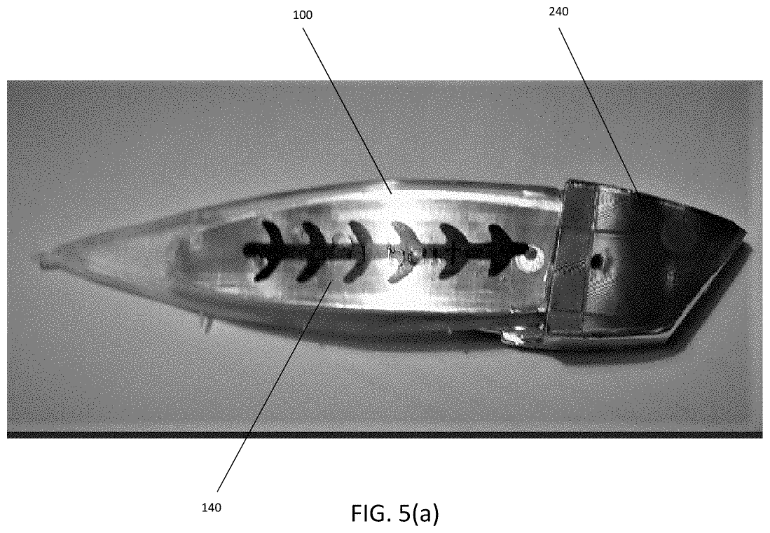

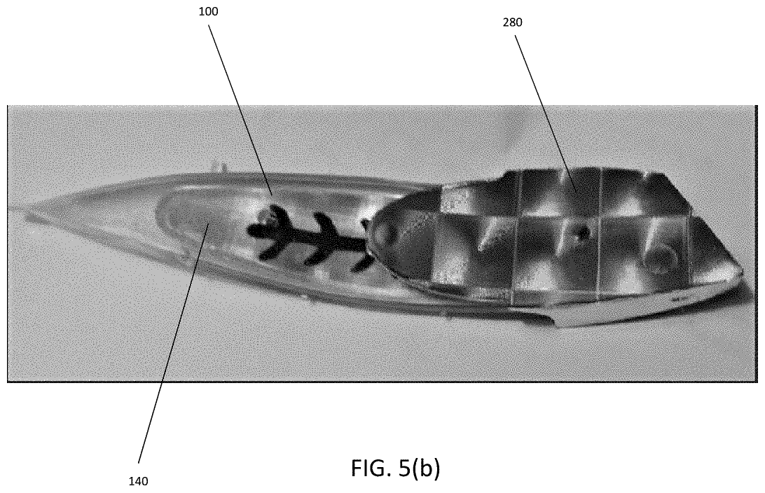

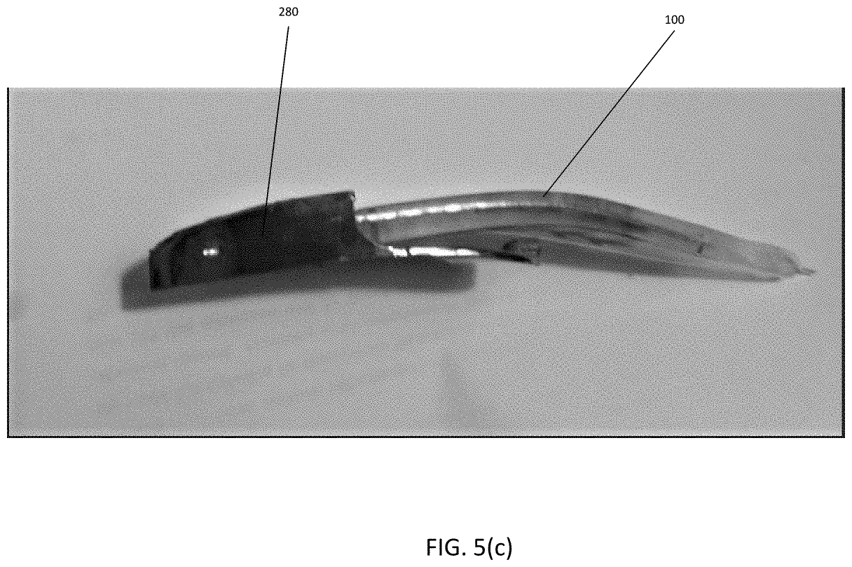

With reference to FIGS. 1, 2(a) and 2(b), the head 108 of the body 104 is further defined by a neck portion 116 which separates the head 108 from the remainder of the body 104 of the bait fish 100. In the herein described embodiment, the neck portion 116 includes a ridge 120 extending between top and bottom sides of the body 104 that is sized and configured to permit fitting of the bait fish 100 to literally any sized conventional meat head (not shown) of a fishing rig, as shown by way of example in FIGS. 5(a)-5(c). The imbedded blade 140, as shown in FIGS. 2(a) and 2(b) extends into the head 108, as well as the majority of the interior of the baitfish 100 with the exception of the tail end 112.

The body 104 is further defined according to this described embodiment by a tapered belly 124 extending between the tail end 112 and the neck portion 116. The tapered belly 124 has a shape or contour that allows the artificial bait fish 100 to roll smoothly through the water when fishing, for example, on either a right or left meat rig head (not shown).

According to this described embodiment, the herein described artificial bait fish 100 includes several through holes and more specifically a front hole 160, an intermediate hole 162 and a rear hole 164. According to this embodiment, each of the holes 160, 162, 164 pass though the thickness of the imbedded blade 140 with the holes 162 and 164 also passing though the soft plastic body 102 in order to permit the passage of hooks (not shown), and enabling attachment to a fishing line or fishing rig, such as those shown by way of example in FIGS. 5(a)-5(c).

Dimensionally and to provide a frame of reference, the herein described artificial bait fish 100 has a length dimension of approximately 5 inches, a maximum width dimension of approximately 1.25 inches and a thickness dimension of approximately 0.125 inches. The imbedded plate 140 according to this embodiment has a length dimension of about 4 inches and a maximum width dimension of about 4 inches. It will be understood to those of adequate skill in the field that each of these parameters can be suitably varied.

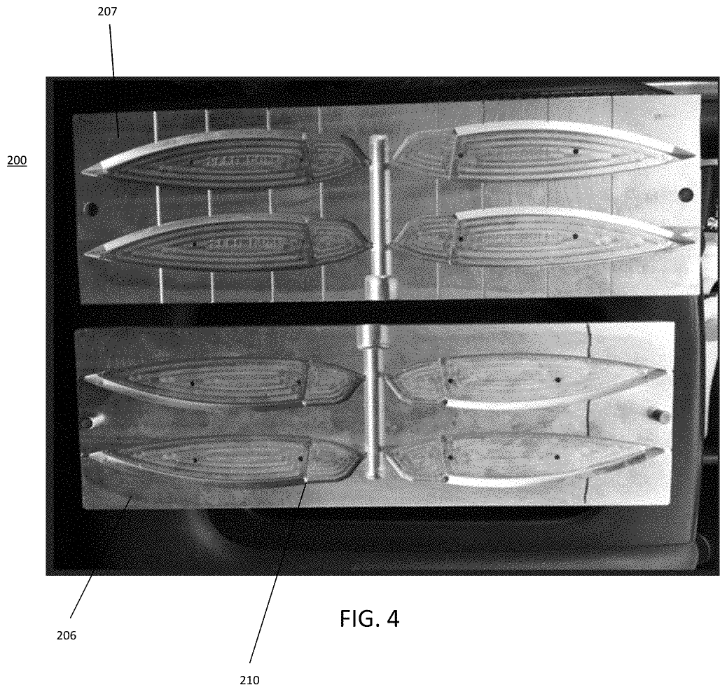

With reference to FIG. 4, an exemplary mold 200 is shown that includes two mold halves 206, 207 that combine to form a mold cavity including at least one internal tab that is inset for the repeatable placement of the imbedded blade.

In terms of manufacture/fabrication of the artificial baitfish 100, the blade 140 is provided having the formed through holes 160, 162, 164 according to this specific embodiment. The blade 140 is machined from aluminum according to this embodiment although other suitable structural materials can be utilized. The colored sections or strips 150 are then applied to each of the respective planar sides of the blade 140. As noted, the colored strips 150 can be adhesively attached to the opposing sides of the blade 140 or alternatively can be attached as in the present embodiment using threaded fasteners 152 that affix the strips 150 via holes that have been previously machined into the blade 140. Alternatively and rather than attaching a separate colored section(s), the opposing planar surfaces of the blade 140 can be painted. In any of the described versions, the color (e.g., green) of the colored strip 150 or the blade 140 is selected to enhance visibility of the artificial bait fish 100 in the water during use.

Next, the blade 140 is inserted into one of the mold halves of the injection mold 200, the mold 200 including a first mold half 206 and a second mold half 207 that are hingably or otherwise attached to each other under pressure. According to this embodiment, the blade 140 is aligned with a set of spaced pins or tabs (not shown) that correspond with two of the through holes 162, 164 previously formed in the blade 140. This configuration further permits the blade 140 to be suspended within the mold 200.

The mold halves 206, 207 are clamped shut under appropriate pressure. Hot fluidized plastisol is then injected into the defined mold cavity, filling the plastic about the suspended blade 140. Each of the mold halves 206, 207 according to this embodiment are configured with a plurality of forms configured to produce multiple baitfish 100 in a single operation. It will be understood that the number of forms in the mold 200 (four according to this embodiment) can be suitably varied.

Each of the forms of the mold 200 are suitably shaped and sized to produce the baitfish 100, including a recessed portion 210 that forms the ridge 120 of the neck portion 116. After a predetermined cooling period following injection, the mold halves 206, 207 are unclamped and the formed artificial bait fish 100 is released from the mold 200. The finished bait fish 100 can be scented in a manner known in the field by means of an impregnated oil.

In terms of use, the artificial bait fish 100 can be used in a myriad of different fishing applications. For purposes of an exemplary configuration, the herein described artificial bait fish 100 is herein described for use with running baits. First and as shown in FIG. 5(a), the head 108, FIG. 2(a) of the artificial bait fish 100 can be inserted into a meat rig 240. Holes formed in the meat head 240 are aligned with the hole 162 formed in the head 108 and the imbedded plate 140 of the bait fish 100. A toothpick, pin or other appropriately sized item (not shown) can then be used to pierce the plastic of the body 100 at the head 108 and secure the artificial bait fish 100 to the meat head 240. The head 108 of the bait fish including the defined ridge 120 is appropriately sized to fit relative to the defined cavity of the meat head 240. This described method can be used for a number of trolling operations, including those used on downrigger, dipsy divers, copper line, lead core line and planer board fishing, among other known trolling methods. It should be noted that other fishing rigs, such as the meat head 280 shown in FIGS. 5(b) and 5(c) can be used, and into which the artificial bait fish 100 can be similarly installed.

To complete the rig, a barrel snap swivel (not shown) can be inserted into the front hole 160 of the artificial bait fish 100 on a metal tab. An appropriate fishing line (not shown) such as Fluorocarbon, monofilament, braided or wire fishing line can then be connected to the barrel snap swivel. The fishing hook can then be attached to the fishing line in order to complete the rig. This method can be used trolling on downrigger, dipsy diver, copper line, lead core line, planer board and casting, among other known trolling methods.

### PARTS LIST FOR FIGS. 1-5(c)

100 artificial bait fish
104 soft plastic body, bait fish
108 front or distal end, body (head)
112 rear, proximal or tail end, body (tail)
116 neck portion
120 ridge
124 tapered belly portion
140 blade
144 angled front end, blade
150 colored strip, blade
152 fasteners, threaded
160 through hole, blade
162 through hole, blade
164 through hole, blade
200 injection mold
206 mold half
207 mold half
210 recessed portion
240 meat head (fishing rig)
280 meat head (fishing rig)

It will be readily apparent that other modifications and variations are possible within the intended scope of the described invention, including the following claims.

1. An artificial bait fish comprising:
a soft plastic body made in the shape of a fish, the body including a head and a tail; and
a blade substantially embedded within the soft plastic body.

2. The artificial bait fish according to claim 1, in which the blade is made from a hard structural material.

3. The artificial bait fish according to claim 1, in which the blade includes at least one through hole.

4. The artificial bait fish according to claim 2, in which the blade is made from aluminum.

5. The artificial bait fish according to claim 1, in which a colored strip is attached to at least one surface of the blade.

6. The artificial bait fish according to claim 5, in which the colored strip is attached to opposing surfaces of the blade.

7. The artificial bait fish according to claim 5, in which the colored strip is attached using at least one of adhesives or fasteners.

8. The artificial bait fish according to claim 5, in which the colored strip is painted onto at least one surface of the blade.

9. The artificial bait fish according to claim 1, in which the body of the bait fish includes a neck having a ridge sized to permit the artificial bait fish to be fitted onto one of various fishing rigs.

10. The artificial bait fish according to claim 9, in which the body is defined by a tapered belly extending from the neck to the tail end of the body, the tapered belly enabling the artificial bait fish to roll smoothly through the water.

11. A method for manufacturing an artificial bait fish, the method comprising the steps of:
providing a blade made from a hard structural material;
disposing the blade within a mold configured to suspend the blade; and
injecting a soft plastic material under pressure about the blade such that the blade is fully imbedded within a soft plastic body.

12. The method according to claim 11, in which the blade is made from aluminum.

13. The method according to claim 11, in which the soft plastic body is in the shape of a fish.

14. The method according to claim 11, further including the step of applying a colored strip to at least one surface of the blade.

15. The method according to claim 14, in which the colored strip is applied to opposing surfaces of the blade.

16. The method according to claim 14, in which the colored strip is applied to the blade using at least one of fasteners or adhesives.

17. The method according to claim 14, in which the colored strip is painted onto at least one surface of the blade.

18. The method according to claim 11, including the step of providing at least one through holes extending through the body and the imbedded blade for retention of fishing hooks.

19. The method according to claim 11, in which the artificial bait fish is provided with a neck portion at a distal end of the body, the neck portion including a ridge to permit the artificial bait fish to be fitted to a plurality of different sized fishing rigs for trolling.

20. The method according to claim 19, in which the body is provided with a tapered belly extending from the neck region to a tail end of the lure, the tapered belly enabling the artificial bait fish to roll smoothly through the water.
